(19) United States
(12) Patent Application Publication
(10) Pub. No.: US 2018/0111259 A1
(43) Pub. Date: Apr. 26, 2018

(54) POWER TOOL

(71) Applicant: HITACHI KOKI CO., LTD., TOKYO (JP)

(72) Inventors: Yuuki TAKEDA, IBARAKI (JP); Takuya YOSHINARI, IBARAKI (JP)

(73) Assignee: HITACHI KOKI CO., LTD., TOKYO (JP)

(21) Appl. No.: 15/569,087

(22) PCT Filed: Mar. 25, 2016
(86) PCT No.: PCT/JP2016/059689

§ 371 Date: Oct. 25, 2017

(30) Foreign Application Priority Data
Apr. 27, 2015 (JP) 2015-090862

(51) Int. Cl. B25F 5/00; B25F 5/02; B24B 23/02; H02P 6/16; H02K 7/14; H02P 6/08

(52) U.S. Cl. CPC B25F 5/001; B25F 5/02; B24B 23/02; H02P 6/08; H02P 6/16; H02K 7/145; B24B 23/022

(57) ABSTRACT

A power tool is provided such that noise can be reduced at a wide range of rotation speeds. A speed setting dial to be operated by a worker is disposed on a rear end part of a housing of a grinder. A control part controls driving of a motor by setting the rotation speed of the motor in response to the value of a speed setting signal which indicates a value (voltage) corresponding to an amount of rotation of the speed setting dial by the worker. Although the control part basically causes the rotation speed of the motor to change continuously in response to the rotation amount of the speed setting dial, the control part sets the rotation speed of the motor while avoiding a predetermined rotation speed region in which the noise level is increased due to mechanical and acoustic resonances.

### TECHNICAL FIELD

The present invention relates to a power tool such as a grinder which is capable of setting a rotation speed of a motor in accordance with a worker's dial operation.

### BACKGROUND ART

Conventionally, a power tool such as a grinder which has a speed change function capable of setting a rotation speed of a motor in accordance with an operation state of a speed setting device such as a dial is known. On the other hand, in the power tool, when the motor reaches a certain rotation number (RPM), a loud sound may be generated due to resonance (resonation) which is caused by rotation of a rotor. Whether the loud sound is generated at a certain RPM varies depending on a size, shape, material, or the like of a housing or the motor. Further, in the power tool using a brushless motor, the brushless motor is more efficient than a motor with a brush, and since a size of the motor can be reduced, there is a high possibility that resonance (resonation) will be generated in a practical rotation speed region of the power tool due to factors such as a low natural frequency of a stator and a large number of poles.

### CITATION LIST

### Patent Literature

[Patent Literature 1]
Japanese Unexamined Patent Application Publication No. 2007-275999

### SUMMARY OF INVENTION

### Technical Problem

As a countermeasure against the resonance (resonation), it is conceivable to adjust a natural frequency of the housing or the motor by changing the size, the shape or the like of the housing or the motor. However, since the RPM used in the power tool having the speed change function has a broad range, it is difficult to avoid the RPM at which the loud sound is generated even when the size, the shape or the like of the housing or the motor is devised, and there is room for improvement in view of noise reduction.

The present invention has been made in view of such a situation, and an object thereof is to provide a power tool which is capable of reducing noise while using a wide range of RPM.

### Solution to Problem

An aspect of the present invention is a power tool. The power tool includes a motor having a stator and rotor, a housing configured to accommodate the motor and to fix the stator, a trigger switch provided in the housing and configured to be operable by a worker and to output an ON/OFF signal of the motor, a speed setting device operated by the worker, and a control part configured to set a rotation speed of the motor according to an operation state of the speed setting device, wherein the control part sets the rotation speed of the motor to avoid a predetermined rotation speed region of the motor at which the stator resonates.

The speed setting device may have an operation part which is operated by the worker so that a relative position to the housing is varied, the control part may set the rotation speed of the motor according to the position of the operation part, and the rotation speed of the motor may be continuously varied according to the position of the operation part at at least a part of the rotation speed excluding the predetermined rotation speed region.

The control part may have a memory part in which a value of a speed setting signal according to the operation state of the speed setting device and a setting rotation speed of the motor are stored to correspond to each other, may read the setting rotation speed according to the operation state of the speed setting device from the memory part, and may set the rotation speed of the motor.

The control part may have an input terminal and may be capable of rewriting a stored content of the memory part with data transmitted through the input terminal.

There may be two or more predetermined rotation speed regions.

The power tool may further include an adjustment signal output part configured to output an adjustment signal to the control part in response to a worker's operation, and when the adjustment signal is received, the control part may be capable of rewriting the stored content of the memory part to exclude the rotation speed at a time of reception and the rotation speed in a vicinity thereof.

The motor may be a brushless motor, and the rotor may have a permanent magnet.

The power tool may include a rotational position detection device which detects a rotational position of the rotor, and the control part may detect the rotation speed of the motor on a basis of an output signal of the rotational position detection device.

The housing may be formed of a resin material.

The power tool may include a speed reduction part configured to decelerate rotation of the rotor, a spindle configured to extend in a direction approximately orthogonal to a rotating shaft of the rotor, and a tip tool installed on the spindle, and the housing may be used as a handle.

The tip tool may be formed in a disk shape and may have a diameter of 100 mm to 250 mm.

In addition, an arbitrary combination of the above constituent elements and a transformation of expressions of the present invention among methods, systems and the like are also effective as embodiments of the present invention.

### Advantageous Effects of Invention

According to the present invention, it is possible to provide the power tool which is capable of reducing noise while using a wide range of RPM.

### BRIEF DESCRIPTION OF DRAWINGS

FIG. 1 is a side cross-sectional view illustrating a state in which an operation switch 5 of a grinder 1 according to an embodiment of the present invention is in an OFF state.

FIG. 2 is a side cross-sectional view illustrating a state in which the operation switch 5 of the grinder 1 is in an ON state.

FIG. 3 is a control block diagram of the grinder 1.

FIG. 4 is a characteristic diagram illustrating a relationship between RPM of a motor 6 of the grinder 1 and a generated sound level.

FIG. 5 is an explanatory diagram illustrating a first example of content of a table stored in a memory part 54a of FIG. 3.

FIG. 6 is a setting rotation speed characteristic diagram illustrating a first example of a relationship between an angle (operation state) of a speed setting dial 62 illustrated in FIG. 1 and so on and a setting rotation speed of the motor 6.

FIG. 7 is a setting rotation speed characteristic diagram illustrating a second example of the above-mentioned relationship.

FIG. 8 is a setting rotation speed characteristic diagram illustrating a third example of the above-mentioned relationship.

FIG. 9 is an explanatory diagram illustrating a second example of the content of the table stored in the memory part 54a of FIG. 3.

FIG. 10 is a setting rotation speed characteristic diagram illustrating a fourth example of the relationship between the angle (position) of the speed setting dial 62 illustrated in FIG. 1 and so on and the setting rotation speed of the motor 6.

FIG. 11 is a flowchart of an adjustment mode for rewriting stored content of the memory part 54a in FIG. 3.

FIG. 12 is a setting rotation speed characteristic diagram in the case in which resonance RPM is changed due to aging deterioration or the like in FIG. 10.

FIG. 13 is a setting rotation speed characteristic diagram after the setting rotation speed of the motor 6 is partially changed from a state of FIG. 12 by performing the adjustment mode.

### DESCRIPTION OF EMBODIMENTS

Hereinafter, preferable embodiments of the present invention will be described with reference to the drawings. Further, the same reference numerals are given to the same or equivalent constituent elements, members, processes, or the like illustrated in each of the drawings, and repeated description will be omitted appropriately. In addition, the embodiments are not intended to limit the invention but are just examples, and all the features described in the embodiments and combinations thereof are not necessarily essential to the invention.

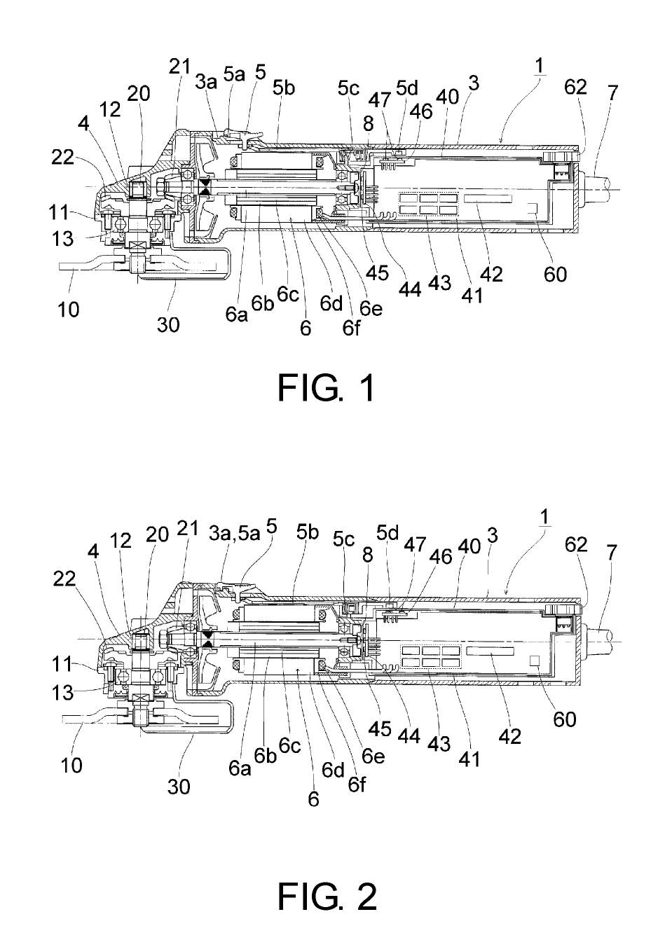

FIG. 1 is a side cross-sectional view illustrating a state in which an operation switch 5 of a grinder 1 according to an embodiment of the present invention is in an OFF state. FIG. 2 is a side cross-sectional view illustrating a state in which the operation switch 5 of the grinder 1 is in an ON state. As illustrated in FIG. 1, the grinder 1 has a grindstone 10 as a tip tool (rotating tool) and is used in a grinding operation which flattens a surface of concrete, a stone material, or the like. The grindstone 10 has a disk shape, and a diameter thereof is, for example, 100 mm to 250 mm. Further, in addition to a disk-shaped polishing grindstone or a cutting grindstone, a disk-shaped brush, a cutter or the like can also be installed as the tip tool. The grinder 1 includes a housing 3 (formed of, for example, a resin) and a gear case 4.

The housing 3 has an approximately cylindrical shape as a whole, and a motor (electric motor) 6 is accommodated inside the housing 3 as a prime mover. The motor 6 is connected to an external AC power supply such as a commercial power supply via a power cord 7 withdrawn from a rear end of the housing 3. A first bevel gear 21 is provided at a front end of an output shaft 6a of the motor 6. The operation switch (trigger switch) 5 for switching energization to the motor 6 (drive and stop of the motor 6) is provided at the housing 3. The operation switch 5 is biased rearward (in a direction in which it turns off) by a spring 5c. However, the operation switch 5 may be locked in the ON state by sliding the operation switch 5 forward and hooking a locking convex portion 5a to a locking concave portion 3a of the housing 3 as illustrated in FIG. 2.

The gear case 4 is formed of a metal such as an aluminum alloy or the like and is installed at a front end of the housing 3. An opening of the gear case 4 is closed by a packing gland 11 as a cover member. The packing gland 11 is fixed to the gear case 4 by, for example, screwing. The packing gland 11 serves as a holding member for holding a wheel guard 30 which will be described later. Two bearings (a needle bearing 12 and a ball bearing 13) are provided inside the gear case 4, and a spindle 20 is rotatably held by these bearings. The spindle 20 is approximately orthogonal to the output shaft 6a (rotor rotating shaft) of the motor 6, and one end thereof passes through the packing gland 11 and protrudes to the outside. On the other hand, a second bevel gear 22 engaging with the first bevel gear 21 installed at the output shaft 6a of the motor 6 is provided (installed) at the other end of the spindle 20 which is located inside the gear case 4. A rotational direction of the motor 6 is changed by 90 degrees by the first bevel gear 21 and the second bevel gear 22 serving as a speed reduction part, and a rotation speed thereof is reduced and transmitted to the spindle 20. That is, the spindle 20 is rotationally driven by the motor 6.

The grindstone 10 is fixed to the spindle 20 by a wheel washer and a lock nut and rotates integrally with the spindle 20. When the operation switch 5 provided at the housing 3 is operated, electric power is supplied to the motor 6, and the output shaft 6a of the motor 6 rotates. Then, the spindle 20 connected to the output shaft 6a via the first bevel gear 21 and the second bevel gear 22 rotates, and the grindstone 10 fixed to the spindle 20 rotates. The wheel guard 30 which covers at least ½ or more of an outer circumference of the grindstone 10 is installed at the packing gland 11. The wheel guard 30 is in a rotation stop state so that a rotational position thereof is not changed while at work and the rotational position can be changed according to the work when the rotation stop state is released.

In the embodiment, the motor 6 is a brushless motor, and a rotor core 6b formed of a magnetic material which rotates integrally with the output shaft 6a is provided around the output shaft 6a. A plurality of (for example, four) rotor magnets (permanent magnets) 6c are inserted into and held in the rotor cores 6b. A stator core 6d is provided (fixed to the housing 3) around the rotor core 6b. In the stator core 6d, a stator coil 6e is provided via an insulator 6f. Further, the housing 3 which holds the stator core 6d is used as a handle of the grinder 1.

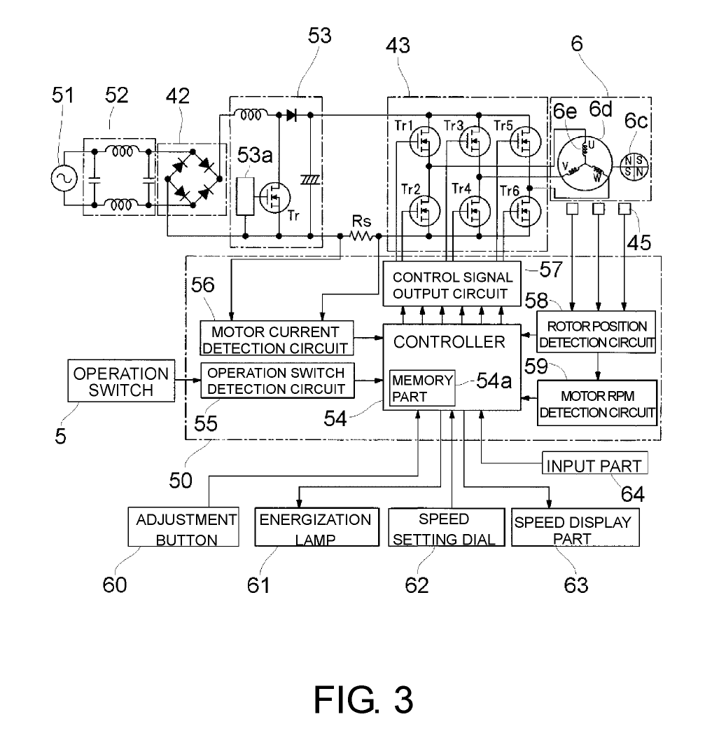

In the housing 3, a controller box 40 is provided at a rear of the motor 6. A main board 41, a sensor board 44 and a switch board 46 are accommodated in the controller box 40. On the main board 41, a diode bridge 42, an inverter circuit 43, a controller (microcomputer) 54 illustrated in FIG. 3 or the like is provided. The sensor board 44 faces a sensor magnet 8 provided at a rear end of the output shaft 6a of the motor 6. On a surface of the sensor board 44 facing the sensor magnet 8, three Hall ICs (magnetic sensors) 45 are provided as a rotational position detection device and arranged at intervals of 60°. By detecting a magnetic field generated by the sensor magnet 8 with the Hall ICs 45, it is possible to detect the rotational position (rotor rotational position) of the motor 6. The switch board 46 faces a switch magnet 5d provided at a distal end of a slide bar 5b which slides in conjunction with an operation of the operation switch 5. The two Hall ICs (magnetic sensors) 47 are provided on a surface the switch base 46 facing the switch magnet 5d. The switch magnet 5d faces one of the Hall ICs 47 according to ON/OFF of the operation switch 5.

The speed setting dial 62 is provided (held) as a speed setting device operated by a worker (user) on the rear end of the housing 3. The speed setting dial 62 is a dial type variable resistor, and a resistance value of the variable resistor changes when the speed setting dial 62 is rotated. A speed setting signal indicating a value (voltage) corresponding to a rotation amount (operation state) of the speed setting dial 62 is input by the worker to the controller 54 illustrated in FIG. 3. The controller 54 sets the rotation speed of the motor 6 according to the value of the input speed setting signal, that is, the operation state of the speed setting dial 62, and controls the driving of the motor 6. The worker can set (adjust) the rotation speed of the motor 6 (rotation speed of the grindstone 10) to a desired speed by operating the speed setting dial 62. The controller 54 basically changes the rotation speed of the motor 6 continuously according to the operation state of the speed setting dial 62 and sets the rotation speed of the motor 6 by avoiding (skipping) a predetermined rotation speed region in which a noise value increases due to resonance or resonation as will be described later.

FIG. 3 is a control block diagram of the grinder 1. The diode bridge 42 is connected to an AC power supply 51 via a filter circuit 52 for a noise countermeasure. An inverter circuit 43 is provided at an output terminal of the diode bridge 42 via a power factor improving circuit 53. The power factor improving circuit 53 includes, for example, a transistor Tr made of a MOSFET and a gate driver IC 53a which outputs a PWM control signal to a gate of the transistor Tr and has a function of suppressing a harmonic current generated in each switching element of the inverter circuit 43 to a limit value or less. For example, the inverter circuit 43 is formed by three-phase bridge connection of switching elements Tr1 to Tr6 made of the MOSFET and supplies a drive current to the motor 6. A detection resistor Rs converts a current flowing to the motor 6 into a voltage.

In FIG. 3, an operation switch detection circuit 55 is constituted with two Hall ICs 47 mounted on the switch board 46 of FIG. 1 and transmits a switch operation detection signal corresponding to a position (ON/OFF) of the operation switch 5 to the controller (microcomputer) 54. The controller 54 turns on an energization lamp 61 when the fact that the operation switch 5 is turned on is detected by the switch operation detection signal.

The speed setting dial 62 transmits the speed setting signal indicating the value corresponding to the state in which it is being operated by the worker to the controller 54. The controller 54 has a memory part 54a in which the value (level) of the speed setting signal and the setting rotation speed of the motor 6 are stored in a table to correspond to each other, and reads the setting rotation speed corresponding to the state in which the speed setting dial 62 is being operated by the worker from the memory part 54a, and sets the rotation speed of the motor 6. Basically, the setting rotation speed that continuously changes according to a change in the value of the speed setting signal is stored in the memory part 54a. However, as will be described later, the setting rotation speed is stored to avoid the predetermined rotation speed region in which the noise value increases due to the resonance or resonation.

A motor current detection circuit 56 identifies the current flowing to the motor 6 on the basis of a terminal voltage of the detection resistor Rs, and transmits a motor current detection signal to the controller 54. A control signal output circuit (gate driver IC) 57 applies a drive signal such as a PWM signal or the like to the gate of each of the switching elements constituting the inverter circuit 43 according to control of the controller 54. A rotor position detection circuit 58 detects a rotational position of a rotor of the motor 6 on the basis of an output signal of the Hall IC 45, and transmits a rotor position detection signal to the controller 54 and a motor RPM detection circuit 59. The motor RPM detection circuit 59 detects RPM (a rotation speed) of the motor 6 on the basis of the rotor position detection signal from the rotor position detection circuit 58, and transmits a motor RPM detection signal to the controller 54.

The controller 54 controls the control signal output circuit 57 according to the switch operation detection signal, the motor current detection signal, the rotor position detection signal, the motor RPM detection signal and the position (operation state) of the speed setting dial 62, drives each of the switching elements constituting the inverter circuit 43, and rotationally drives the motor 6. The controller 54 notifies the worker of the rotation speed of the motor 6 through a speed display part 63. An adjustment button (adjustment switch) 60 is provided as an adjustment signal output part on the main board 41 and is an operation part which issues instructions to perform rewriting and to start and end an adjustment mode in which the worker rewrites the stored content of the memory part 54a. When the adjustment button 60 is pressed for a long time, an adjustment mode start or end signal is transmitted to the controller 54, and when the adjustment button 60 is pressed for a short time, the adjustment signal is transmitted to the controller 54. The adjustment mode will be described later. An input part (input terminal) 64 is a terminal for inputting data of a new table to the memory part 54a, and the controller 54 is capable of rewriting the stored content of the memory part 54a based on the data of the table transmitted through the input part 64.

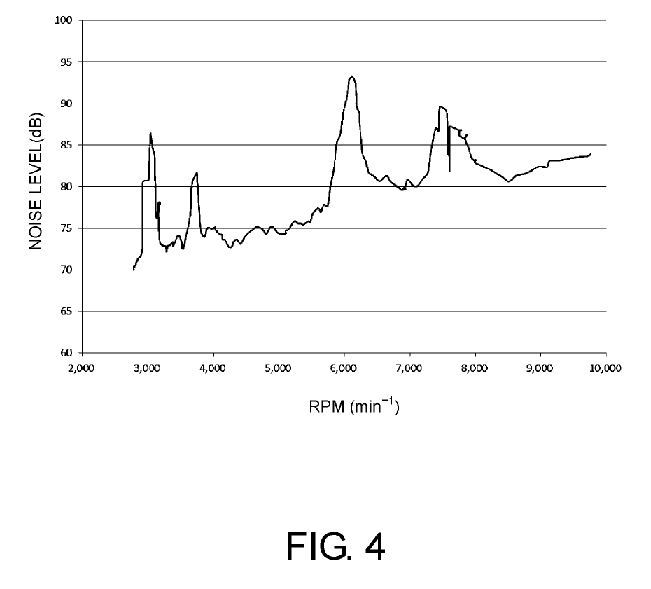

FIG. 4 is a characteristic diagram illustrating a relationship between the RPM of the motor 6 in the grinder 1 and a generated sound level. As illustrated in FIG. 4, in the grinder 1, a loud sound close to 90 dB is generated when the RPM of the motor 6 is around 6000 rpm and around 7,500 rpm. This is caused by the resonance (resonation) of a stator of the motor 6. Particularly, in the grinder 1, since the motor 6 serving as a drive source is a brushless motor, vibration due to a magnetic attraction force (cogging torque) between the rotor and the stator also overlaps, and a harsh and sharp sound is generated. Further, In the case of a compact one such as a portable power tool like the grinder 1 (a tip tool is small), a housing thereof has low rigidity, and thus the resonance is easily generated. Therefore, in the embodiment, the configuration in which the rotation speed of the motor 6 is continuously changed according to the operation state of the speed setting dial 62 is used, and the rotation speed of the motor 6 is set to avoid the vicinity of 6000 rpm and the vicinity of 7,500 rpm in which the loud sound is generated, and the noise is reduced even though a wide range of RPM is used.

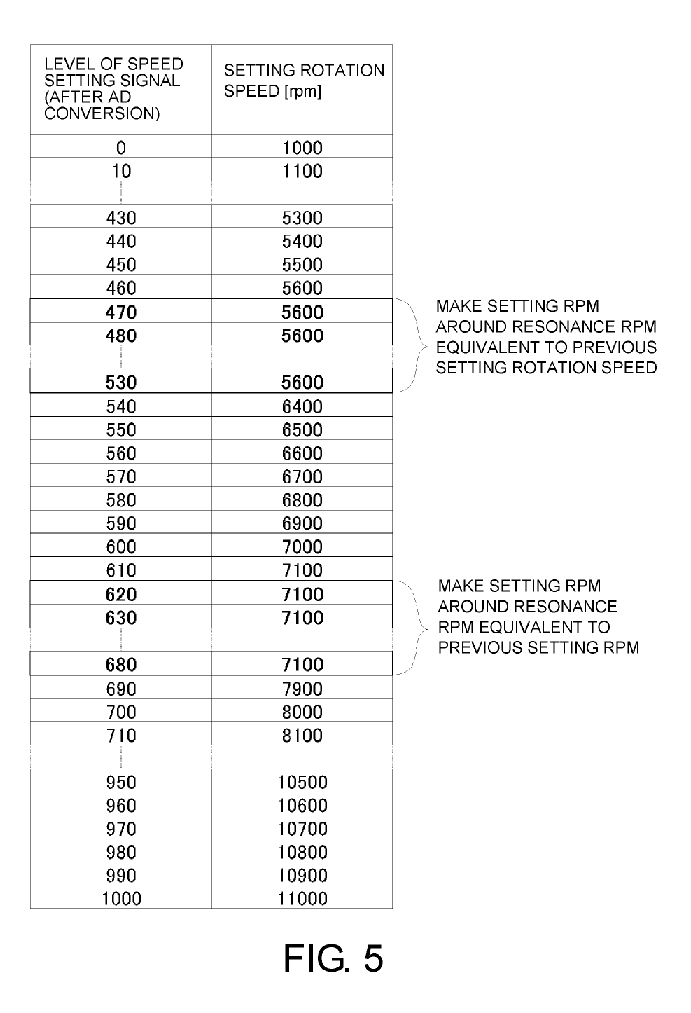

FIG. 5 is an explanatory diagram illustrating a first example of the content of the table stored in the memory part 54a of FIG. 3. In FIG. 5, in a level of the speed setting signal, a value in which an output signal of the speed setting dial 62 which is an analog signal is converted into a 10-bit digital signal is indicated in decimal notation. Further, although the level of the speed setting signal is illustrated in increments of 10 in FIG. 5, it is actually stored in increments of one in the memory part 54a. The example of FIG. 5 has the stored content in which a range of 400 rpm around 6000 rpm and 7000 rpm at which the loud sound is generated due to the resonance (resonation) is excluded from the setting rotation speed and in the other range, whenever the level of the speed setting signal is increased by 1, the setting rotation speed is increased by 10 rmp. Specifically, when the level of the speed setting signal exceeds 460 and is also less than 540, the setting rotation speed (5600 rpm) which is equivalent to the case in which the level of the speed setting signal is 460 is stored, and when the level of the speed setting signal is 540, the setting rotation speed is increased at a stroke by 800 rpm, and 6400 rpm is stored. Similarly, when the level of the speed setting signal exceeds 610 and is also less than 690, the setting rotation speed (7100 rpm) which is equivalent to the case in which the level of the speed setting signal is 610 is stored, and when the level of the speed setting signal is 540, the setting rotation speed is increased at a stroke by 800 rpm, and 7900 rpm is stored. In the example of FIG. 5, if it is a rule (normal continuous change) that the setting rotation speed is increased by 10 rmp whenever the level of the speed setting signal is increased by 1, a setting RPM (5600 rpm or 7100 rpm) just before the corresponding range is stored in a portion in which the setting rotation speed in the range of 400 rpm around 6000 rpm or 7500 rpm is stored. Since the controller 54 reads the setting rotation speed corresponding to the level of the speed setting signal from the memory part 54a and sets the rotation speed of the motor 6, the rotation speed of the motor 6 is set to avoid the range of 400 rpm around 6000 rpm and 7000 rpm at which the loud sound is generated due to the resonance (resonation).

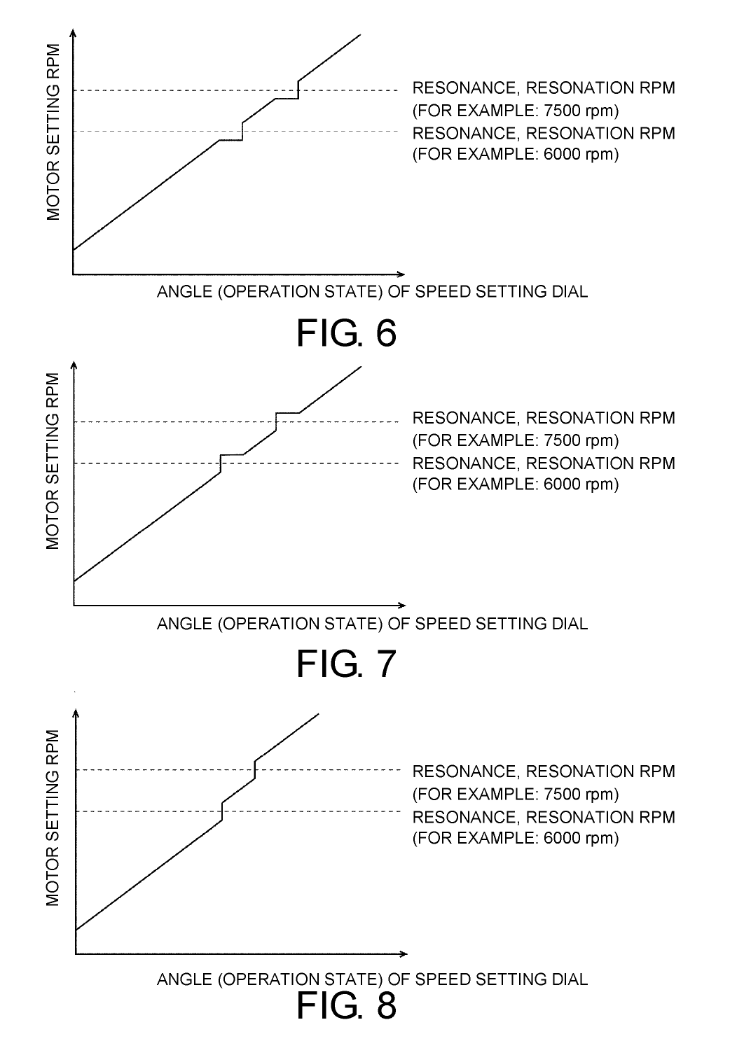

FIG. 6 is a setting rotation speed characteristic diagram illustrating a first example of a relationship between an angle (operation state) of the speed setting dial 62 illustrated in FIG. 1 and so on and the setting rotation speed of the motor 6. FIG. 7 is a setting rotation speed characteristic diagram illustrating a second example of the above-mentioned relationship. FIG. 8 is a setting rotation speed characteristic diagram illustrating a third example of the above-mentioned relationship. The first example illustrated in FIG. 6 corresponds to the case in which the content of the table of the memory part 54a is the same as that illustrated in FIG. 5. The second example illustrated in FIG. 7 corresponds to the case in which, in the normal continuous change, the setting RPM (6400 rpm or 7900 rpm) just after the corresponding range is stored in a portion of the table of the memory part 54a in which the setting rotation speed in the range of 400 rpm around 6000 rpm or 7500 rpm is stored. The third example illustrated in FIG. 8 corresponds to the case in which the table of the memory part 54a has the content in which the range of 400 rpm around 6000 rpm or 7500 rpm is skipped without providing a range in which the setting rotation speed becomes constant. In any of the examples illustrated in FIG. 6 to FIG. 8, since the motor 6 rotates at a rotation speed in which the range of 400 rpm around 6000 rpm or 7500 rpm at which the loud sound is generated is avoided, the noise is suppressed.

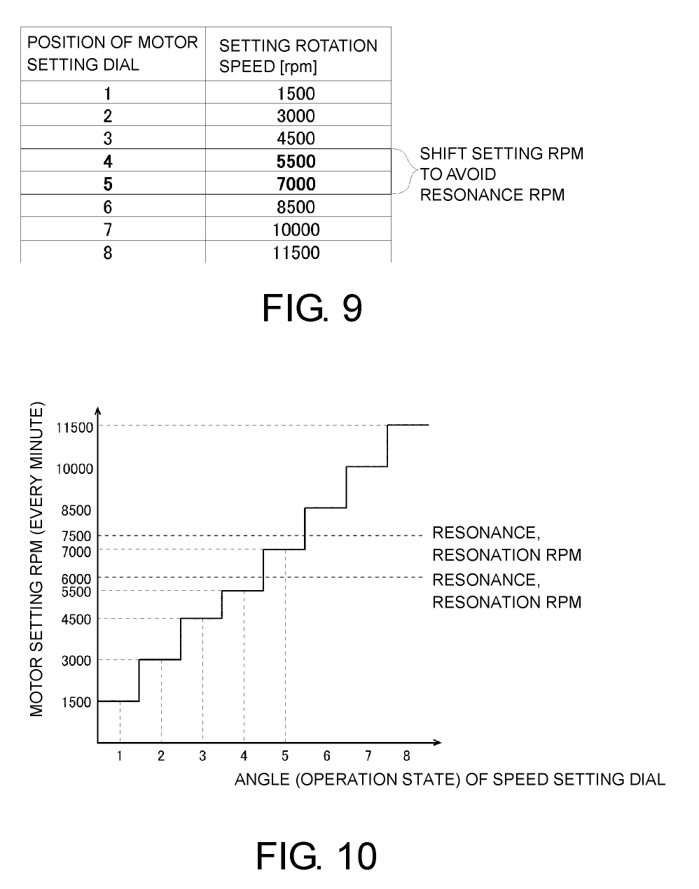

FIG. 9 is an explanatory diagram illustrating a second example of the content of the table stored in the memory part 54a of FIG. 3. FIG. 10 is a setting rotation speed characteristic diagram illustrating a fourth example of the relationship between the angle (position) of the speed setting dial 62 illustrated in FIG. 1 and so on and the setting rotation speed of the motor 6. The examples of FIG. 5 to FIG. 8 correspond to the case in which the rotation amount of the speed setting dial 62 changes continuously, but the examples of FIG. 9 and FIG. 10 correspond to the case in which the rotation amount of the speed setting dial 62 changes stepwise (in this example, in eight steps). In the examples of FIG. 9 and FIG. 10, when the speed setting dial 62 is “1”, a minimum setting rotation speed is set to 1500 rpm, and basically when the speed setting dial 62 is rotated one step, the setting rotation speed is changed by 1500 rpm, but only when the speed setting dial 62 is rotated between “3” and “4”, the change in the setting rotation speed is set to 1000 rpm. Accordingly, the rotation speed around 6000 rpm and 7500 rpm at which the loud sound is generated can be avoided, and thus the noise is suppressed.

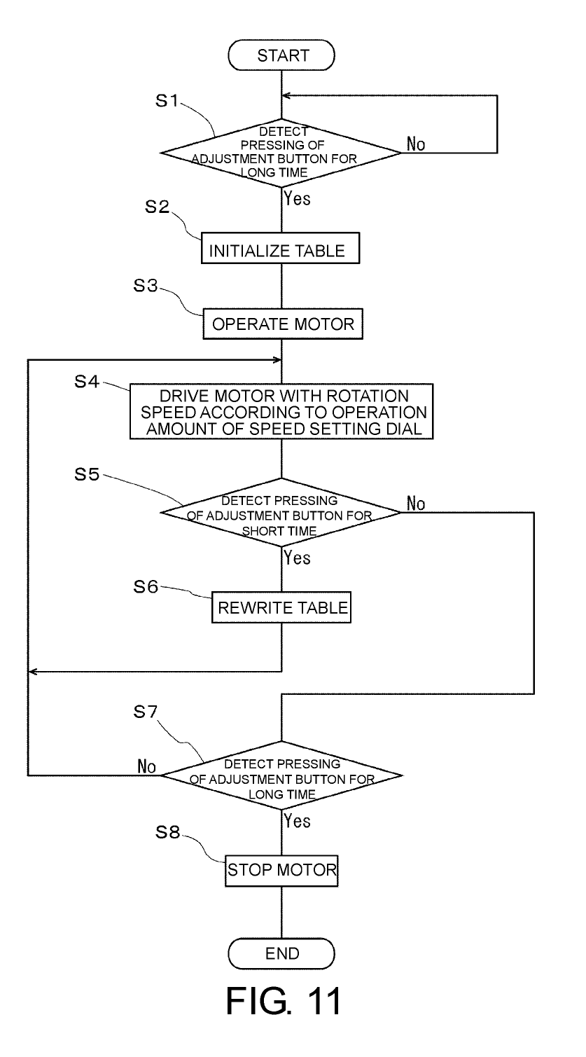

FIG. 11 is a flowchart of the adjustment mode for rewriting stored content of the memory part 54a in FIG. 3. This flowchart illustrates a control flow in the case in which the worker rewrites the table of the memory part 54a illustrated in FIG. 5 afterwards. The controller 54 starts the adjustment mode when it is detected that the adjustment button 60 is pressed for a long time (S1, Yes), that is, when an adjustment mode start signal is received. Specifically, the controller 54 initializes the table of the memory part 54a (S2) and operates the motor 6 (S3). Further, here, the initialization of the table includes setting the setting rotation speed to a stored state with the rule in which the setting rotation speed is increased by 10 rmp whenever the level of the speed setting signal is increased by 1 with respect to the entire range of the level of the speed setting signal. The controller 54 drives the motor 6 at a rotation speed according to an operation amount of the speed setting dial 62 (S4) and rewrites the content of the table (S6) when the adjustment button 60 is pressed for a short time during the driving of the motor 6 (S5, Yes), that is, when the adjustment signal is received. Specifically, the controller 54 replaces the setting RPM of a range of, for example, around 400 rpm in the RPM of the motor 6 when the adjustment button 60 is pressed for a short time with, for example, the rotation speed just before or just after the range. The worker can exclude a plurality of different rotation speed regions from the setting rotation speed by changing the speed setting dial 62 and pressing the adjustment button 60 for a short time again. The controller 54 stops the motor 6 (S8) and terminates the adjustment mode when it is detected that the adjustment button 60 is pressed for a long time (S7, Yes), that is, when an adjustment mode end signal is received. Further, the adjustment mode start signal and the adjustment mode end signal are signals showing the same level change, and when the adjustment mode is not performed, it is processed as the adjustment mode start signal, and when the adjustment mode is performed, it is processed as the adjustment mode end signal.

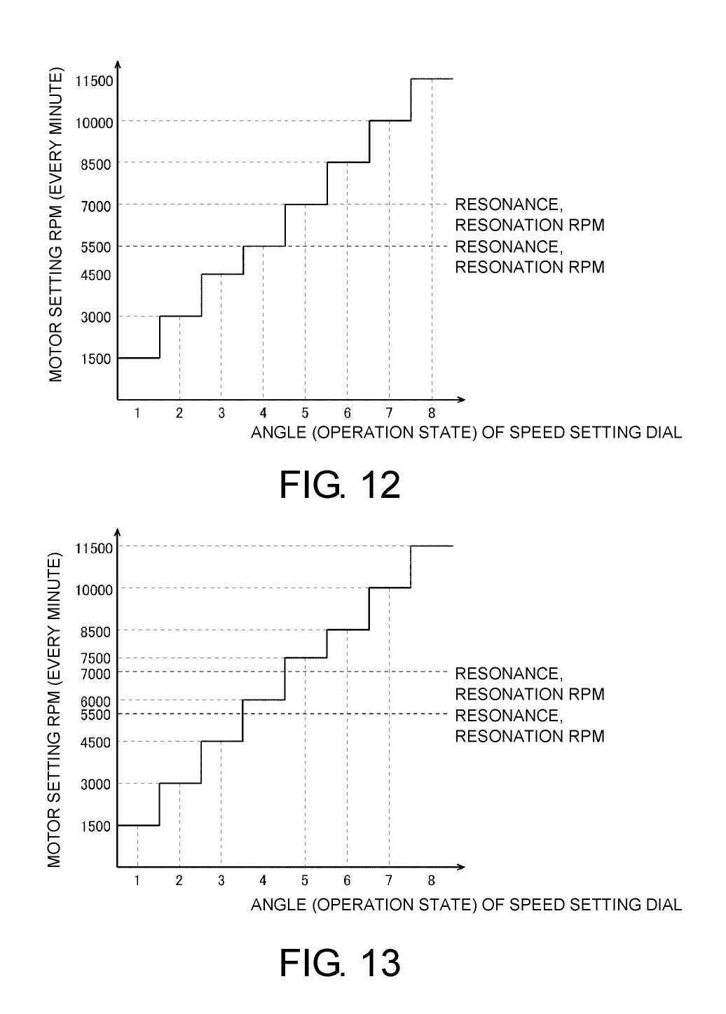

FIG. 12 is a setting rotation speed characteristic diagram in the case in which the resonance RPM is changed due to aging deterioration or the like in FIG. 10. In the grinder 1, due to prolonged use, wear of components may progress or the housing 3 may be deformed, and thus the resonance RPM at which the loud sound is generated may be changed. Further, the resonance RPM may be changed by exchanging the components. FIG. 12 illustrates the case in which the setting rotation speed when the position of the speed setting dial 62 is “4” and “5” is the rotation speed at which the loud sound is generated by the resonance due to the aging deterioration or the like. In addition, FIG. 12 is the same as FIG. 10 except that the resonance RPM is changed.

FIG. 13 is a setting rotation speed characteristic diagram after the setting rotation speed of the motor 6 is partially changed from the state of FIG. 12 by performing the adjustment mode. The example of FIG. 13 illustrates the case in which, in the adjustment mode, the worker shifts the setting rotation speed when the position of the speed setting dial 62 is “4” and “5” to be 500 rpm higher by pressing the adjustment button 60 for a short time when the position of the speed setting dial 62 is “4” and “5”. Therefore, even when the aging deterioration or the like occurs and the resonance RPM is changed, the noise can be reduced.

According to the embodiment, the following effects can be obtained.

(1) Since the controller 54 sets the rotation speed of the motor 6 to avoid the predetermined rotation speed region at which the loud sound is generated due to the resonance (resonation), the noise can be reduced while a wide range of RPM is used. Such an effect is particularly remarkable in the power tool such as a portable power tool in which the resonance is easily generated due to the small size and the low rigidity of the housing or the power tool in which the brushless motor is used as the drive source and thus the sharp sound is generated at a predetermined RPM due to electromagnetic vibration (vibration in which cogging torque serves as excitation force).

(2) By performing the adjustment mode illustrated in FIG. 11, the worker can determine the rotation speed region to be excluded from the setting rotation speed by himself/herself and can set it according to a difference in the resonance RPM due to an individual difference of the product. Further, even when the natural frequency around the housing or the motor varies due to factors such as the aging deterioration or the component replacement, it is possible to cope with the variation by resetting the RPM to be avoided, and thus it is possible to continuously suppress the noise. Furthermore, since data of a new table can be input into the memory part 54a through the input part 64, it is convenient.

Although the present invention has been described with reference to the embodiment as an example, it is understood by those skilled in the art that each constituent element and each processing process of the embodiment can be variously modified within the range described in the claims. Hereinafter, a modified example will be described.

There may be one or three or more predetermined rotation speed regions excluded from the setting rotation speed. The predetermined rotation speed region is not limited to the specific range exemplified in the embodiment but may be appropriately set to correspond to the size and shape of the housing or the motor. Widths of the plurality of rotation speed regions excluded from the setting rotation speed need not be the same as each other but may be appropriately set for each region so that the noise can be effectively reduced. The adjustment button 60 and the input part 64 may be omitted as long as it is not necessary to rewrite the table of the memory part 54a afterwards.

The power tool is not limited to the grinder exemplified in the embodiment but may be another type of power tool having a speed change function such as a multi-cutter, a jig saw or the like. The drive source of the power tool is not limited to the brushless motor and may be a motor with a brush. The number of steps of the speed setting dial 62 illustrated in the examples of FIG. 9 and FIG. 10 is not limited to 8 and can be set to an arbitrary number. Further, in the above-described embodiment, the trigger switch and the speed setting device are separately constructed but may be, for example, a monolithic constitution in which the setting speed is changed according to a pulling amount of the trigger switch. In this case, since the trigger switch also serves as the operation portion, it is possible to reduce the number of components. Further, the adjustment button may not be installed on the board but may be operable from the outside.

### REFERENCE SIGNS LIST

1 Grinder
3 Housing
3a Locking concave portion
4 Gear case
5 Operation switch (trigger switch)
5a Locking convex portion
5b Slide bar
5c Spring
5d Switch magnet
6 Motor (electric motor)
6a Output shaft
6b Rotor core
6c Rotor magnet (permanent magnet)
6d Stator core
6e Stator coil
6f Insulator
7 Power cord
8 Sensor magnet
10 Grindstone
11 Packing gland (holding member)
12 Needle bearing
13 Ball bearing
20 Spindle
21 First bevel gear
22 Second bevel gear
30 Wheel guard
40 Controller box
41 Main board
42 Diode bridge
43 Inverter circuit
44 Sensor board
45 Hall IC (magnetic sensor)
46 Switch board
47 Hall IC (magnetic sensor)
50 Control part
51 AC power supply
52 Filter circuit
53 Power factor improving circuit
54 Controller (microcomputer)
54a Memory part
55 Operation switch detection circuit
56 Motor current detection circuit
57 Control signal output circuit (gate driver IC)
58 Rotor position detection circuit
59 Motor RPM detection circuit
60 Adjustment button (adjustment switch)
61 Energization lamp
62 Speed setting dial
63 Speed display part
Rs Detection resistor

1. A power tool, comprising:
a motor, having a stator and rotor;
a housing, configured to accommodate the motor and to fix the stator;
a trigger switch, provided in the housing and configured to be operable by a worker and to output an ON/OFF signal of the motor;
a speed setting device, operated by the worker; and
a control part, configured to set a rotation speed of the motor according to an operation state of the speed setting device,
wherein the control part sets the rotation speed of the motor to avoid a predetermined rotation speed region of the motor at which the stator resonates.

2. The power tool according to claim 1, wherein
the speed setting device has an operation part which is operated by the worker so that a relative position to the housing is varied,
the control part sets the rotation speed of the motor according to a position of the operation part, and the rotation speed of the motor is continuously varied according to the position of the operation part at at least a part of the rotation speed excluding the predetermined rotation speed region.

3. The power tool according to claim 1, wherein
the control part has a memory part in which a value of a speed setting signal according to the operation state of the speed setting device and a setting rotation speed of the motor are stored to correspond to each other, reads the setting rotation speed according to the operation state of the speed setting device from the memory part, and sets the rotation speed of the motor.

4. The power tool according to claim 3, wherein
the control part has an input terminal and is capable of rewriting a stored content of the memory part with data transmitted through the input terminal.

5. The power tool according to claim 1, wherein
there are two or more predetermined rotation speed regions.

6. The power tool according to claim 3, further comprising:
an adjustment signal output part, configured to output an adjustment signal to the control part in response to a worker's operation,
wherein, when the adjustment signal is received, the control part is capable of rewriting the stored content of the memory part to exclude the rotation speed at a time of reception and the rotation speed in a vicinity thereof.

7. The power tool according to claim 1, wherein
the motor is a brushless motor, and
the rotor has a permanent magnet.

8. The power tool according to claim 1, further comprising:
a rotational position detection device, which detects a rotational position of the rotor,
wherein the control part detects the rotation speed of the motor on a basis of an output signal of the rotational position detection device.

9. The power tool according to claim 1, wherein
the housing is formed of a resin material.

10. The power tool according to claim 1, further comprising:
a speed reduction part, configured to decelerate rotation of the rotor;
a spindle, configured to extend in a direction approximately orthogonal to a rotating shaft of the rotor; and
a tip tool, installed on the spindle,
wherein the housing is used as a handle.

11. The power tool according to claim 10, wherein
the tip tool is formed in a disk shape and has a diameter of 100 mm to 250 mm.
